(19) United States
(12) Patent Application Publication
(10) Pub. No.: US 2008/0096066 A1
(43) Pub. Date: Apr. 24, 2008

(54) Power-supply unit

(76) Inventors: Yoshiyuki Takamori, Hitachinaka (JP); Shuichi Suzuki, Hitachi (JP); Yasuaki Norimatsu, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/657,687

(22) Filed: Jan. 25, 2007

(30) Foreign Application Priority Data
Oct. 20, 2006 (JP) 2006-285663

(51) Int. Cl. H01M 8/04

(52) U.S. Cl. 429/23

(57) ABSTRACT

An object of the present invention is to provide a power supply unit configured with a fuel cell generating electric power that is stable over a longer period than similar prior art power supply units, which is achieved by preventing the accumulation of peroxides, one major cause of decreasing the MEA performance, thus extending the lifetime of the MEA. There is provided a power supply unit for supplying electric power to equipment, the power supply unit comprising a fuel cell and a control unit which controls an electrical load that is applied to the fuel cell, wherein a specified load and a low load where a cathode potential becomes higher than the cathode potential under the specified load are applied to the fuel cell alternately as the electrical load.

### CLAIM OF PRIORITY

The present application claims priority from Japanese application serial no. 2006-285663, filed on Oct. 20, 2006, the content of which is hereby incorporated by reference into this application.

### FIELD OF THE INVENTION

The present invention relates to a power supply unit using a fuel cell.

### BACKGROUND OF THE INVENTION

A fuel cell is an electricity generating device which comprises at least a solid or liquid electrolyte and two electrodes consist of an anode and a cathode capable of inducing electrochemical reaction. The fuel cell converts chemical energy of fuel used for the fuel cell directly into electric energy at a high efficiency. For the fuel, hydrogen produced by chemical conversion of fossil fuel or water, methanol, alkali hydride, or hydrazine which is a liquid or solution under normal circumstances, or dimethyl ether which is a pressurized liquefied gas is used. For oxidant gas, air or oxygen gas is used. The fuel is electrochemically oxidized at the anode, while oxygen is reduced at the cathode, so that an electrical potential difference is produced between both the electrodes. Under such a condition, when a load as an external circuit is applied between the electrodes, movement of ions in the electrolyte is caused, so that electric energy is output to the external load. Various kinds of fuel cells actively have been developed for practical applications because they are expected to be used for a large-scale power generating system as an alternative to thermal power generation systems, a small-scale distributed cogeneration system, and a power supply for electric vehicles as an alternative to an engine generator.

The current large problem to be solved is that the lifetime of a Membrane Electrode Assembly (MEA) as an electric power generating portion of a fuel cell is short and this is a large bottleneck inputting fuel cells into practical use. A commonly used MEA is composed of a perfluoro sulfuric acid membrane typified by Nafion, an anode electrode consisting of a carbon with a supported platinum-ruthenium and a cathode electrode consisting of a carbon with a supported platinum. The membrane constitutes the central portion of the MEA, and the anode and the cathode are provided on both sides of the membrane, respectively. One of major causes of decreasing the MEA performance is the generation of peroxides at the cathode. The peroxides are produced as by-products when oxygen is reduced at the cathode. The peroxides induce oxidative destruction of the electrolytic membrane, resulting early reduction in the MEA performance is occurred.

Therefore, a method of providing a catalyst layer capable of decomposing peroxides on any of the electrolytic membrane, anode, and cathode is proposed (Japanese patent publication No. 2005-538508).

### SUMMARY OF THE INVENTION

The present invention is proposed to prevent the accumulation of peroxides as one major cause of early reduction in the MEA performance and increase life of the MEA. Consequently, the present invention is also to provide a power supply unit with a fuel cell capable of generating stable electric power over a longer period than similar prior art power supply units.

The present invention is a power supply unit for supplying electric power to equipment; and which comprises a fuel cell and a control device for controlling an electrical load that is applied to the fuel cell; wherein the power supply unit is configured to apply a specified load and a low load where a cathode potential becomes higher than the cathode potential under the specified load to the fuel cell cyclically as the electrical load.

According to the present invention, it is possible to provide a power supply unit with a fuel cell generating electric power stable over a longer period than similar prior art power supply units.

### BRIEF DESCRIPTION OF THE DRAWINGS

FIG. 1 shows equilibrium concentration of peroxides in relation to cathode potential.

FIG. 2 illustrates a load mode in which a pulse waveform current is applied according to one embodiment of the invention, with a constant current load as a comparative example.

FIG. 3 illustrates a load mode in which a saw-tooth waveform current is applied according to another embodiment of the invention.

FIG. 4 illustrates a load mode in which a sine waveform current is applied according to yet another embodiment of the invention.

FIG. 5 is a graphic representation of the results of fuel cell lifetime tests performed using the load modes of the embodiments and the comparative example.

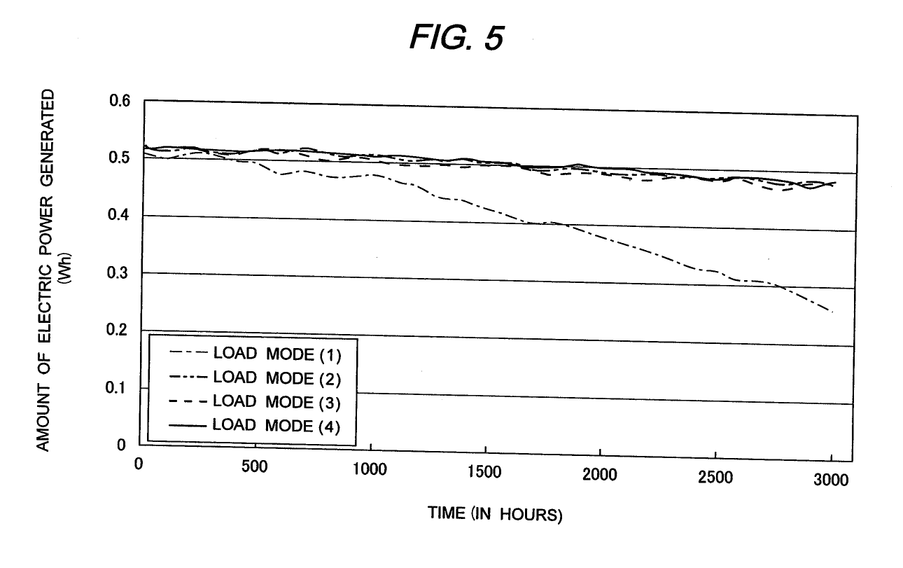

FIG. 6 is a block diagram showing an example of a power supply unit in which a method of operating the fuel cell in the present invention can be used, illustrated in a fourth embodiment of the invention.

FIG. 7 is a schematic of an example of an application of the power supply unit in which a method of operating the fuel cell in the present invention can be used to a charger for a laptop PC.

FIG. 8 is a schematic of another example of an application of the power supply unit in which a method of operating the fuel cell in the present invention can be used to a charger for a mobile phone.

FIG. 9 is a block diagram showing another example of a power supply unit in which a method of operating the fuel cell in the present invention can be used, illustrated in a fifth embodiment of the invention.

### DETAILED DESCRIPTION OF THE PREFERRED EMBODIMENTS

In a method for controlling a power supply unit comprising at least two types of power supply components, namely, a fuel cell and an auxiliary power supply for supplying electric power to equipment, the present invention is characterized in that a cyclically changing load such as pulse wave, triangular wave, and sine wave is applied to the fuel cell to prevent the accumulation of peroxides produced as by-products by cell reaction, thus extending the lifetime of the MEA.

In the following, embodiments of the present invention will be described in detail. In the following description, a Direct Methanol Fuel Cell (DMFC) which generates electric power by supplying a methanol solution to the anode and supplying oxygen (air) to the cathode is taken as an example and discussed. However, the same effect is obtained with a fuel cell using an alcohol fuel other than methanol. Also in PEFC which supplies hydrogen to the anode, the effect of the present invention is obtained in a similar fashion.

When a fuel cell is operated continuously under a constant load, the supply of oxygen necessary for reaction is blocked by the accumulation of water generated at the cathode and the potential of the cathode decreases. As the cathode potential decreases, more peroxides are produced and the peroxides induce oxidative destruction of the electrolytic membrane. This makes the electrolytic membrane unable to function as the proton conduction membrane and decreases the performance, eventually, making the fuel cell unable to generate electric power.

According to the embodiments as will be discussed below, the MEA can have a longer lifetime and an electronic device using the MEA can be used continuously for a longer time than with a similar prior art power supply unit.

### First Embodiment

A method of operating the power supply unit according to a first embodiment will be described below.

In the fuel cell, during the generation of electric power, peroxides are produced at the cathode, as expressed by a reaction formula below:
O₂+2H⁺+2e⁻→H₂O₂ (Formula 1)

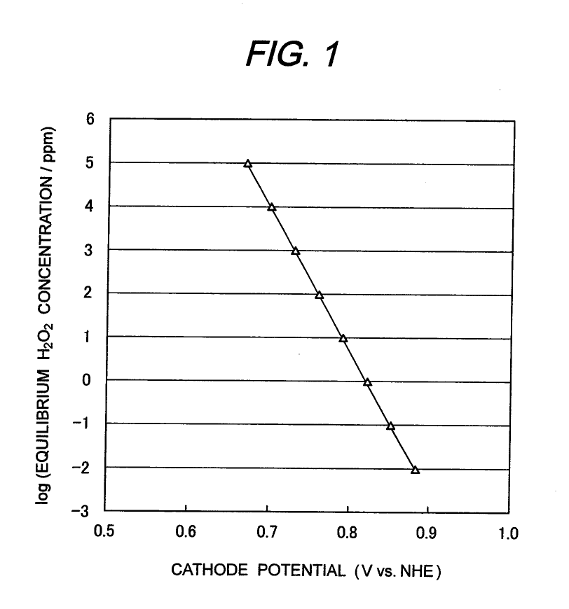

Equilibrium concentration of peroxides in relation to cathode potential is shown in FIG. 1. From this figure, it is seen that the equilibrium concentration of peroxides increases rapidly, as the cathode potential decreases. When the fuel cell generates electric power under a constant load, the cathode potential decreases in response to the load and peroxides are produced. With a larger load, the cathode potential decreases more rapidly and, consequently, a greater amount of peroxides is produced at the cathode. This shortens the lifetime of the fuel cell. Meanwhile, when decreasing the load applied to the fuel cell or stopping the generation of electric power, the cathode potential will rise and the equilibrium concentration of peroxides will decrease. Consequently, in consideration of such a phenomenon, the inventors find that the MEA lifetime can be increased if the peroxides produced and accumulated at the cathode can be decomposed. With this idea, the inventors attempted to operate the fuel cell to generate electric power, while changing the load applied to the fuel cell. As a result, it could be confirmed that the lifetime of the MEA is increased by carrying out this manner of power generation with the load being changed.

The operating method for preventing a reduction in the MEA performance is described in detail. It should be noted that the present invention is not limited to the embodiments discussed below.

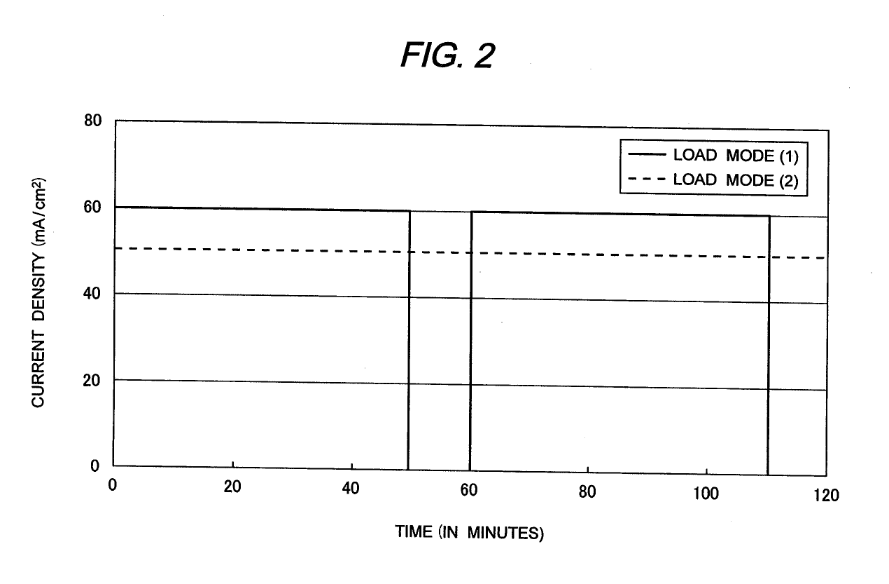

FIG. 2 illustrates the waveform of a load applied to the fuel cell relevant to the first embodiment. A load mode (1), which is a comparative example, is a mode in which power is generated under a normal constant load and power generation is performed at a constant current density of 50 mA/cm². A load mode (2) is an operating method of the present invention in which the application of a load of 60 mA/cm² and intermission are repeated alternately and cyclically. The length of the intermission in cycle is set so that the total coulombs generated in the load mode (2) become equal to those generated in the load mode (1). By doing so, given that the power supplied by the fuel cell in the load mode (1) is the equivalent required by equipment using the fuel cell, the fuel cell can supply the required power to the equipment totally in the load mode (2) as well. The power supply unit is equipped with an auxiliary power supply chargeable and dischargeable, e.g., a lithium secondary battery, along with the fuel cell of the first embodiment. In this power supply unit, when the fuel cell generates power in excess of the required power, the lithium secondary battery is charged with the excess power. In case of shortage of the power generated in the fuel, the shortage can be supplemented by discharging the lithium secondary battery.

According to the present embodiment, it is possible to prevent the accumulation of peroxides becoming the cause of the oxidative destruction in the electrolytic membrane and increase the lifetime of the MEA, and also increase the lifetime of the power supply unit.

### Second Embodiment

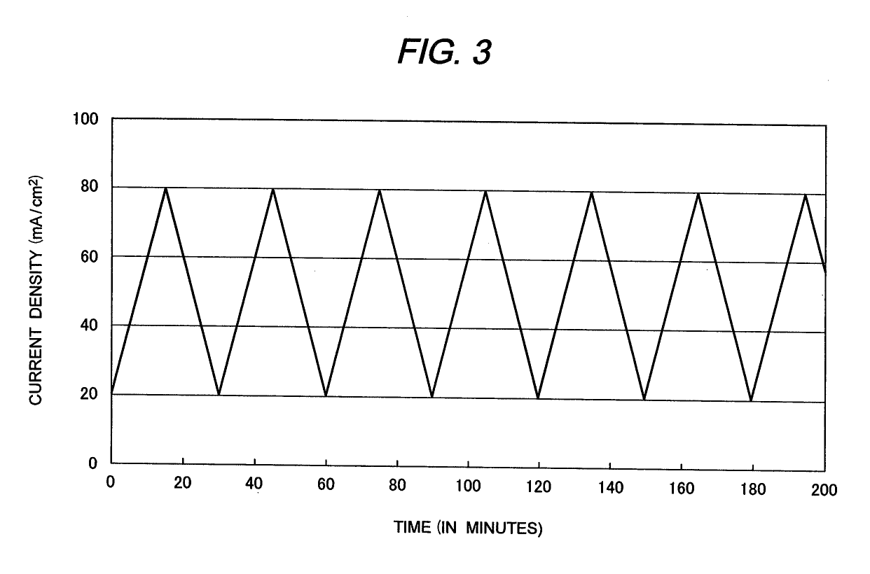

FIG. 3 illustrates the waveform of a load in a load mode (3) applied to the fuel cell relevant to a second embodiment of the invention. In the load mode (3), the load is applied as a triangular wave current in which the peak load current density is 80 mA/cm², the lower limit load current density is 20 mA/cm², and one cycle is 30 minutes. In this embodiment also, the peak current value is set so that the total coulombs generated in the load mode (3) becomes equal to those generated in the load mode (1) as the comparative example.

### Third Embodiment

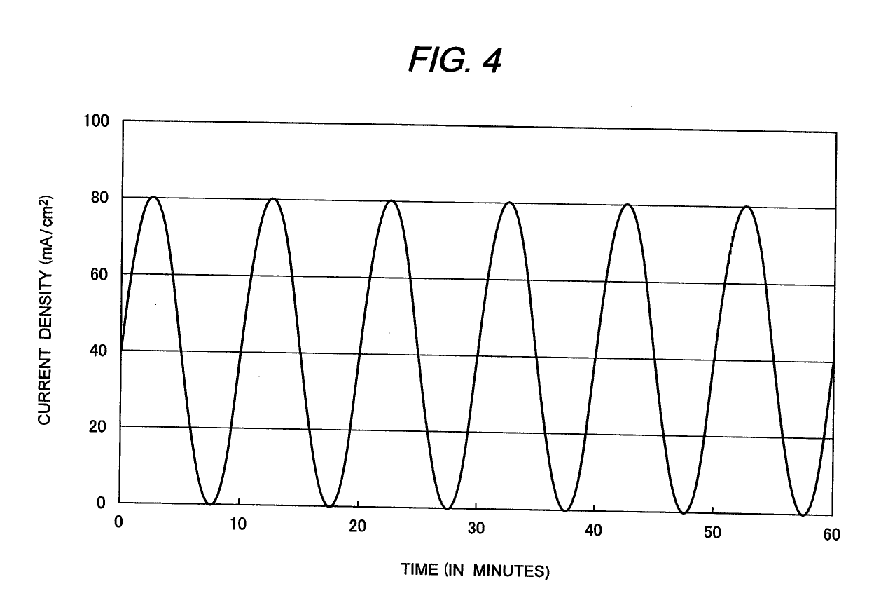

FIG. 4 illustrates the waveform of a load in a load mode (4) applied to the fuel cell relevant to a third embodiment of the invention. In the load mode (4), the load is applied as a sine wave current in which the peak load current density is 80 mA/cm² and one cycle is 10 minutes. In this embodiment also, the peak current value is set so that the total coulombs generated in the load mode (4) becomes equal to those generated in the load mode (1) as the comparative example.

The load in the load mode (1) as the comparative example and the respective loads in the load modes (2) to (4) according to the embodiments were actually applied to the fuel cell and the MEA lifetime was evaluated. In the MEA put to power generation tests, Nafion 117 was used for the electrolytic membrane, TEC10E50E made by Tanaka Kikinzoku kogyo K. K, mixed in a Nafion solution, was used for the cathode, TEC61E54 made by Tanaka Kikinzoku Kogyo K. K, mixed in a Nafion solution, was used for the anode. The fabricated MEA was loaded into a cell for fuel cell evaluation and the power generation tests were performed. In the power generation tests, a 5 wt % methanol solution was used as fuel and the air supply condition was natural ventilation without using auxiliary equipment. The power generation tests were carried out in an environment where temperature was regulated at 30° C. The loads corresponding to the waveforms illustrated in FIGS. 2 to 4 were applied to the fuel cell and the time-varying amount of electric power generated in each mode was measured. According to the results of the tests, the respective time-varying reductions of the cell voltages in the load modes (2) to (4) were smaller than the corresponding time-varying reduction of the cell voltage in the load mode (1) and it was confirmed that the MEA deterioration is suppressed by changing the load cyclically.

The waveforms illustrated herein are examples applied in the present invention and the load cycle, load current waveform, and the like are not limited.

### Fourth Embodiment

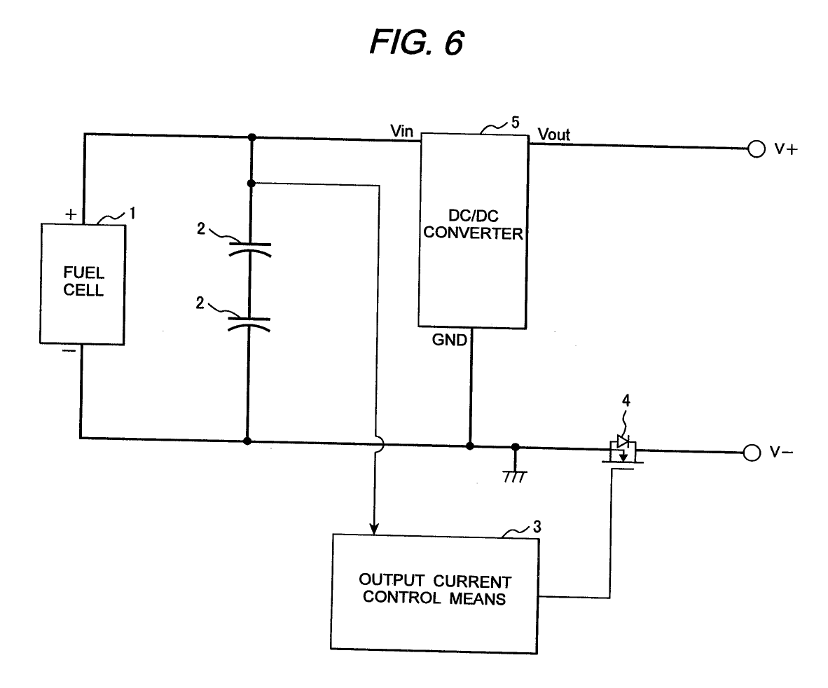

The following embodiment illustrates an example of a power supply unit to which the fuel cell operating method according to the present invention is applied. FIG. 6 is a block diagram outlining the configuration of the power supply unit, power line and signal line connections to realize the present invention.

In the fourth embodiment, the number of cells in a fuel cell unit used for the power supply unit is set so that the maximum fuel cell voltage does not exceed the withstand voltage of an electric double layer capacitor.

One feature of the configuration of the fourth embodiment is that the power supply unit is equipped with two types of power supply components: a fuel cell unit 1 and an electric double Layer capacitor (EDLC) 2. It will be appreciated that a secondary battery typified by a lithium ion secondary battery capable of supplying required power output may be used instead of the EDLC. To simplify the structure, it is desirable that the fuel cell unit 1 is comprised of DMFCs having a simpler structure than other fuel cells. In FIG. 6, two serial EDLCs 2 are used, but the number of cells in the fuel unit must be determined so that the maximum voltage (in an open-circuit state) calculated from the number of serial cells in the fuel cell unit required for power output does not exceed the withstand voltages of the EDLCs 2.

The circuit including the above two types of power supply components is further equipped with a DC/DC converter 5 which converts the voltages supplied from the two types of power supply components into a given output voltage (voltage between Vout and GND), a load cutoff switch 4 for controlling the supply of the electric power to a load and the cut off thereof, and an output current control section for controlling the ON/OFF of the load cutoff switch and the fuel cell output according to any of the waveforms as illustrated in FIGS. 2 to 4. For the output current control section, a one-chip microcomputer or a dedicated IC may be used.

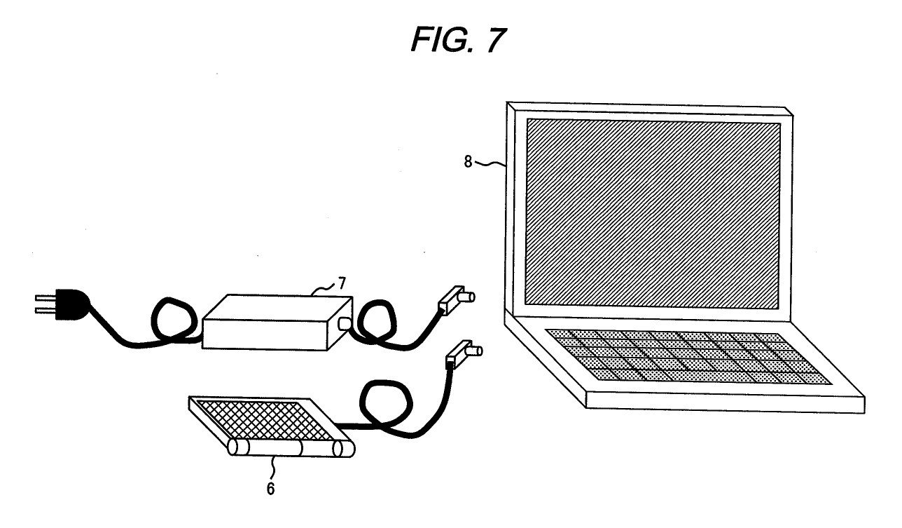

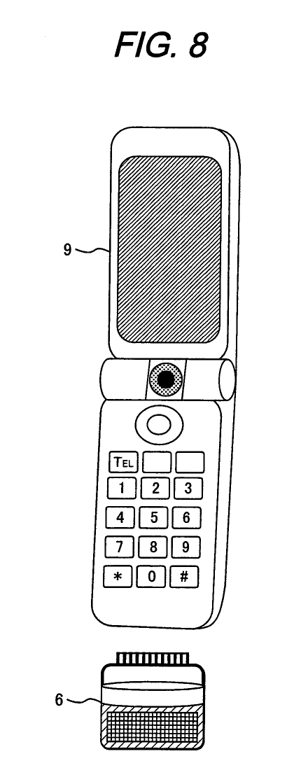

Then, examples of applications of the power supply unit relevant to the present embodiment as the power supply of an electronic device are shown in FIGS. 7 and 8.

FIG. 7 shows an example of an application to a laptop type PC as the electronic equipment that uses the power supply unit. The power supply unit 6 is compatible with an AC adapter for the laptop type PC which is the device using the power supply unit. Connection terminals V+ and V− to the load, as shown in FIG. 6, are configured such that they can be connected to an AC adapter terminal for the laptop type PC. A voltage compatible with the AC adapter (such as 16V, 19V, or 20V) between V+ and V− is output by the DC/DC converter 5.

FIG. 8 shows another example of an application to a mobile phone as the electronic equipment that uses the power supply unit. A voltage compatible with an AC adapter for the mobile phone (such as 5.5V) between V+ and V− at the connection terminals to the load, as shown in FIG. 6, is output by the DC/DC converter 5.

### Fifth Embodiment

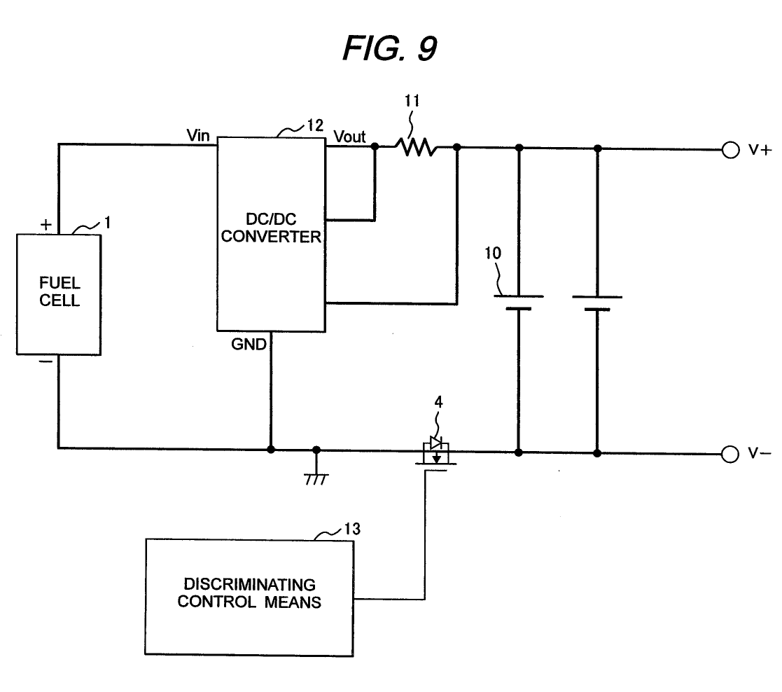

FIG. 9 is a block diagram outlining the configuration of a power supply unit, power line and signal line connections relevant to a fifth embodiment of the invention.

One feature of the configuration of the fifth embodiment is that the power supply unit is equipped with two types of power supply components: a fuel cell unit 1 and a lithium ion secondary battery 10. It will be appreciated that other secondary batteries or the EDLC capable of supplying required power output may be used instead of the lithium ion secondary battery. In FIG. 9, two parallel lithium ion secondary batteries 10 are used, but in practical application, these secondary batteries may optionally be installed in accordance with the power output required by a device that uses the power supply unit.

The circuit including the above two types of power supply components is further equipped with a DC/DC converter 12 with an output current control section, a load cutoff switch 4 for controlling the supply of the electric power to a load and cutoff thereof, and a control section 13 for controlling ON/OFF of the load cutoff switch. The output current control section in DC/DC converter 12 converts the voltages supplied from these power supply components into a given output voltage (voltage between Vout and GND) and controls the output according to any of the waveforms as illustrated in FIGS. 2 to 4 by feeding back a fuel cell output current signal through a shunt resistor 11 installed in the circuit.

What is claimed is:

1. A power supply unit for supplying electric power to equipment, the power supply unit comprising a fuel cell and a control device for controlling an electrical load that is applied to said fuel cell, wherein the power supply unit is configured to apply a specified load and a low load where a cathode potential becomes higher than the cathode potential under said specified load to said fuel cell cyclically as said electrical load.

2. The power supply unit according to claim 1, wherein an intermission of power generation of said fuel cell occurs when said low load is applied.

3. The power supply unit according to claim 1, wherein said specified load is higher than an average power required by said equipment and said low load is lower than the average power required by said equipment.

4. The power supply unit according to claim 1, wherein said specified load and said low load alternate cyclically.

5. The power supply unit according to claim 1, wherein said electrical load is applied in at least one of sine wave, triangular wave, and pulse wave forms.

6. A power supply unit for supplying electric power to equipment, the power supply unit comprising a fuel cell, a control section for controlling an electrical load that is applied to said fuel cell, and an auxiliary power supply which is chargeable and dischargeable,
wherein the power supply unit is configured to apply a specified load and a low load where a cathode potential becomes higher than the cathode potential under said specified load to said fuel cell cyclically as said electrical load, and make charge of excess power from the fuel cell to said auxiliary power supply when the fuel cell generates electric power in excess of power required by said equipment.

7. A power supply unit for supplying electric power to equipment, the power supply unit comprising a fuel cell, a control section for controlling an electrical load that is applied to said fuel cell, and an auxiliary power supply which is chargeable and dischargeable,
wherein the power supply unit is configured to apply a specified load and a low load where a cathode potential becomes higher than the cathode potential under said specified load to said fuel cell cyclically as said electrical load, and
wherein said auxiliary power supply is configured to discharge supplemental electric power for making up for a shortage of the electric power when the electric power generated by said fuel cell falls short of power required by said equipment.

8. A fuel cell system using for the power supply unit according to claim 1, wherein fuel of said fuel cell is at least either hydrogen or alcohol liquid fuel and an oxidant is a gas including oxygen.

9. The power supply unit according to claim 6, wherein said auxiliary power supply is a nonaqueous secondary battery.

10. An electronic equipment with said power supply unit according to claim 1, comprising said equipment and said power supply unit.

11. The power supply unit according to claim 6, wherein said auxiliary power supply is an electric double layer capacitor.
